(19) United States
(12) Patent Application Publication
(10) Pub. No.: US 2023/0105501 A1
(43) Pub. Date: Apr. 6, 2023

(54) Energy Efficient Distillation

(71) Applicant: Anton Petrov, Russian Federation (RU)

(72) Inventor: Anton Petrov, Russian Federation (RU)

(21) Appl. No.: 17/909,752

(22) PCT Filed: Mar. 3, 2021
(86) PCT No.: PCT/IB2021/051780

§ 371 Date: Sep. 6, 2022

Related U.S. Application Data
(60) Provisional application No. 62/984,320, filed on Mar. 3, 2020.

(51) Int. Cl. B01D 3/00; B01D 3/14

(52) U.S. Cl. CPC B01D 3/007; B01D 3/14; C02F 1/043

(57) ABSTRACT

An energy efficient distillation process is provided. Energy efficiency originates from a combination two processes: a) the vaporization occurring with high pressure and high temperature, which decreases enthalpy of vaporization, where the enthalpy of vaporization can be equal to zero if the vaporization occurs to critical state of vaporizing fluid; and b) thermal energy and hydraulic energy of vaporized fluid return to the feed liquid with the system of heat exchangers and pressure exchangers. The energy efficient distillation herein can be applied in multiple existing distillation processes.

### CROSS-REFERENCE TOI RELATED APPLICATIONS

This application claims priority to U.S. Provisional Patent Application No. 62/984,320 entitled Energy Efficient Distillation Process filed on Mar. 3, 2020, which is hereby incorporated in its entirety.

### TECHNICAL FIELD

The present invention relates to a method of improving the efficiency of distillation process by decreasing waste energy in condenser, with an option running with no condenser at all. More specifically, the energy of condensing fluid is used to heat and pressurize the feed liquid.

### BACKGROUND OF THE INVENTION

When one fluid from mixture blend vaporizes and condensates, a distillation process occurs. This process in basic models needs energy, which is then wasted in condenser. There are some methods to reduce the waste including the following below.

Vapor-compression distillation involves raising pressure and temperature in a condenser, which allows for heating of the feed liquid.

Multistage Stage Flash Distillation (MSFD) is a water desalination process that distills sea water by flashing a portion of the water into steam in multiple stages of which are essentially countercurrent heat exchangers.

Multiply-effect distillation (MED) is a distillation process used for seawater desalination, which consists of multiple stages or “effects”. At each stage, the feed water is heated by steam in tubes, usually by spraying saline water onto the tubes such that some of the water evaporates. This steam flows into the tubes of the next stage, thereby heating and evaporating more water.

Vapor compression distillation, MSFD, and MED are not able to use maximum consumed energy in distillation process and minimize energy losses, as disclosed in the systems and methods herein.

### BRIEF SUMMARY OF EMBODIMENTS OF THE INVENTION

In a variant, a distillation system comprises: a heater; a first feed line configured to deliver a liquid feed mixture at a first pressure and a first temperature; a pressure exchanger configured to change a fluid pressure of the liquid feed mixture to a level above the first pressure to a vicinity of a critical pressure of a vaporizing fluid; a countercurrent heat exchanger configured to receive the liquid feed mixture from the pressure exchanger and to heat the liquid feed mixture; wherein the heater is configured to receive the liquid feed mixture and to heat the liquid feed mixture to a temperature in a vicinity of the critical pressure of a vaporizing fluid, thereby yielding the vaporizing fluid as an outgoing fluid near a critical point thereof; wherein the outgoing fluid from the heater is received by the countercurrent heat exchanger such that the liquid feed mixture is heated to a temperature proximate to the outgoing fluid and the outgoing fluid is cooled in the countercurrent heat exchanger, thereby condensing the outgoing fluid into an outgoing liquid; and wherein the pressure exchanger is configured to receive the outgoing liquid from the heat exchanger such that the pressure exchanger reduces a pressure of the outgoing liquid in order to increase the fluid pressure of the liquid feed mixture to a level above the first pressure to at least a critical pressure of the vaporizing fluid, and output the outgoing liquid.

In another variant, the distillation system further comprises a pump for circulating the liquid feed mixture, outgoing fluid, and outgoing liquid.

In yet another, the distillation system further comprises a fractional column configured to receive the outgoing fluid from the heater for cooling, condensing, and vaporizing the outgoing fluid multiple times until the outgoing fluid is purified at an end of the fractional column; wherein the end of the fractional column is connected to the countercurrent heat exchanger.

In a variant, distillation system comprises a heater; a first feed line configured to deliver a liquid feed mixture at a first pressure and a first temperature; a first pressure exchanger configured to change a fluid pressure of the liquid feed mixture to a level above the first pressure to at least a critical pressure of vaporization of a vaporizing fluid; a second pressure exchanger configured to change a fluid pressure of the liquid feed mixture to a level above the first pressure to at least a critical pressure of vaporization of the a countercurrent heat exchanger configured to receive the liquid feed mixture from both first and second pressure exchangers and to transport the liquid feed mixture to the heater; wherein the heater is configured to receive the liquid feed mixture, heat the liquid feed mixture, and vaporize the liquid feed mixture into an outgoing vapor; wherein the countercurrent heat exchanger is configured to receive the outgoing vapor and receive a second outgoing liquid via two separate lines from the heater such that the liquid feed mixture is heated to a temperature proximate to the outgoing vapor and the outgoing vapor is cooled into a first outgoing liquid; wherein the first outgoing liquid is cooled in the countercurrent heat exchanger and the first pressure exchanger is configured to receive the first outgoing liquid from the heat exchanger such that the pressure exchanger reduces a pressure of the first outgoing liquid in order to increase the fluid pressure of the liquid feed mixture to a level above the first pressure to at least a critical pressure of the vaporizing fluid, and output the first outgoing liquid; and wherein the second outgoing liquid is cooled in the countercurrent heat exchanger and the second pressure exchanger is configured to receive the second outgoing liquid from the heat exchanger such that the pressure exchanger reduces a pressure of the second outgoing liquid in order to increase the fluid pressure of the liquid feed mixture to a level above the first pressure to at least a critical pressure of the vaporizing fluid, and output the second outgoing liquid.

In another variant, the first feed line is divided into a second and third feedline that feeds the respective first and second pressure exchangers.

In yet another variant, respective output lines from the first and second pressure exchangers that combine into a single line feeding into the countercurrent heat exchanger.

In yet another further variant, the first line is operatively connected to a pump the liquid feed mixture to the concurrent heat exchanger.

### BRIEF DESCRIPTION OF THE DRAWINGS

FIG. 1 is a diagram showing a basic distillation process.

FIG. 2 is a diagram illustrating the principle of high-efficient pressure exchangers.

FIG. 3 shows a basic energy efficient distillation process. The liquid blend is fed into system and the system returns fluid 4 as a liquid. The heat is not wasted in the proposed system.

FIG. 4 is a temperature graph of basic energy efficient distillation, showing critical point situation. Fluid 4 evaporates from the mixture to critical state, then releases its heat through heat exchanger to feed mixture, and then gives back its pressure energy to feed mixture.

FIG. 5 is a diagram showing temperature mode in the heater of basic energy efficient distillation process (FIG. 4) shown more detail.

FIG. 6 is a diagram showing a combination of fractional distillation with energy efficient distillation equipped with a fractional column installed over the heater.

FIG. 7 is a diagram showing a combination of continuous distillation with energy efficient distillation.

### DETAILED DESCRIPTION OF THE EMBODIMENTS OF THE INVENTION

The systems and methods herein may minimize energy waste in distillation applications, desalination or fluid concentration applications, and whenever energy efficiency is critical. Key aspects of the system and methods herein include: (1) the processing temperatures are close to critical temperature of vaporizing fluid and (2) usage of highly efficient pressure exchangers to recover the pressure energy. The aspects of the systems and methods herein allow for (1) incorporation into existing distillation methods, which (2) provides upgrades to existing distillation methods; and (3) reduction of the operating cost of the distillation.

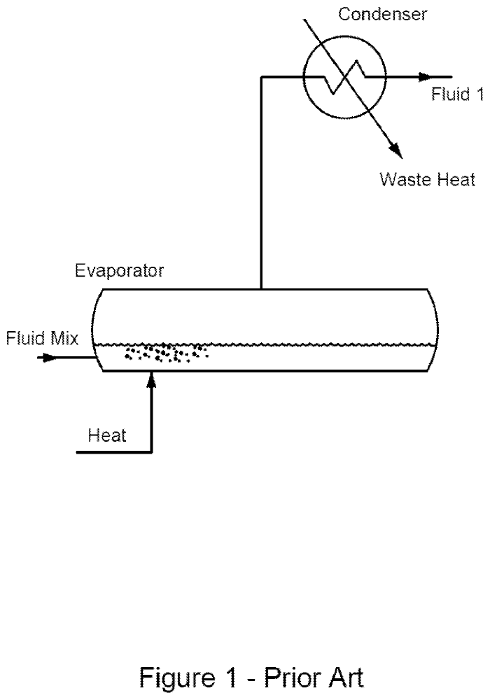

Referring to FIG. 1, a fluid mixture is pumped to an evaporator in a basic distillation process. Fluid 1 evaporates from the fluid mix and condenses in condenser. The energy, which is used to heat the mixture and evaporate fluid 1 from the mixture, is lost in the condenser. For example, approximately 2258 kJ for each 1 kg of distillate or 627 kilowatt-hours (kWh) for 1 ton as a minimum amount of energy is wasted for a water distillation. This schematic can incorporate processes of the systems and methods herein, thereby leading to energy efficient distillation. In contrast to the basic distillation process depicted in FIG. 1, at least all of the energy of condensation process is wasted, rendering the distillation as energy inefficient.

The most energy-effective schematic for seawater desalination spends about 40-60 kWh. In contrast, the setup of the systems and methods herein spend about 10 kWh. Stated another way, the difference in comparison to systems and methods herein and the most energy-effective schematic is 30-50 kWh, which corresponds to not fully recuperated condensation heat.

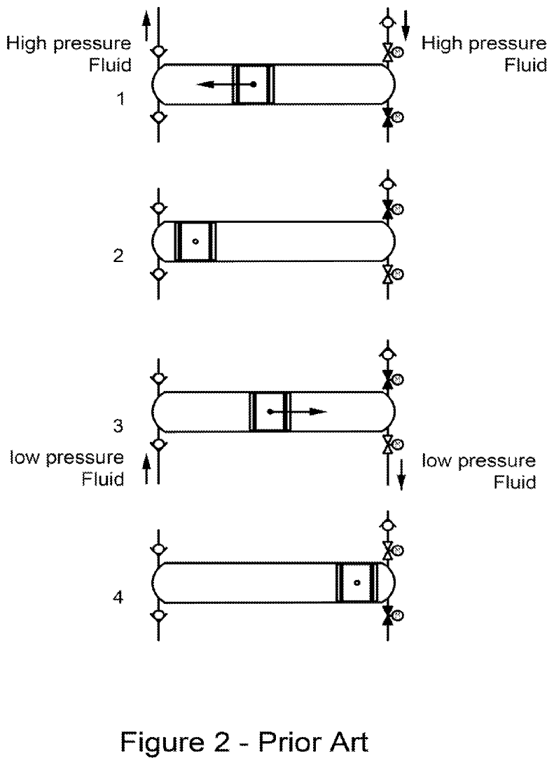

Referring to FIG. 2, there are several types of pressure exchangers that can be applied for incorporation into existing distillation processes by the systems and methods herein. More particularly, FIG. 2 depicts a particular type of pressure exchanger, which is demonstrated to have over 90% efficiency. Other types of pressure exchangers (PX) can be used with the systems and methods herein which have full, leak-less separation of liquids.

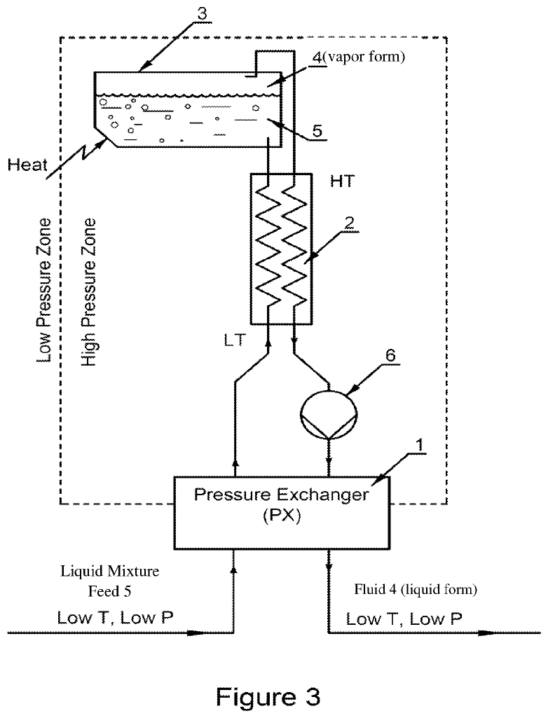

FIG. 3 depicts a basic energy efficient distillation system, in which a condenser is obviated by the usage of evaporation to the critical state of a fluid. The latent heat at the critical state of the fluid is zero. Stated another way, energy waste from heat does not accumulate in a region which would have had a condenser. The condenser-less design of FIG. 3 features heater 3, wherein fluid 4 has zero latent heat. There are two pressures in the systems and methods herein, low pressure (LP) of the source fluid and high pressure (HP) to guarantee the critical state of fluid, whereby the pressure is equal to or higher than the critical pressure.

When balancing out the system, the pressure exchanger 1 switches fluid over the lower pressure and high pressure. For example, liquid A with LP and Liquid B with HP are inputted and liquid A with HP and Liquid B with LP is outputted. Instead, pressure exchanger 1 is holding the high-pressure zone border. The high pressure is created by heat or heat and compensation feed line (which is not shown or not always necessary). When liquid feed mixture 5 crosses the low-to-high pressure border through the pressure exchanger 1, the liquid feed mixture 5 then passes through heat exchanger 2. More particularly, the liquid feed mixture 5 enters the system through a first feed line to pressure exchanger 1 at low pressure LP and low temperature LT. The first line corresponds to a LT line. Pressure exchanger 1, which pressurizes the liquid feed mixture 5 to a high pressure (HP), is operatively connected to heat exchanger 2 along the first feed line corresponding to the low temperature line.

Heat exchanger 2 receives the liquid feed mixture 5 at the low temperature and high pressure along the first feed line corresponding to the low temperature line. Heat exchanger 2 operates most efficiently using counter flows. In some embodiments of the present invention, the flow rate of an incoming liquid (e.g., the liquid feed mixture 5) definitely exceeds the counter-flow of an outgoing fluid. Thus, the liquid feed mixture 5 is able to take maximum thermal energy from an outgoing fluid, and is routed to heater 3 at the temperature close to that of outgoing liquid at a high temperature. This occurs because the flow of the outgoing fluid (e.g., liquid state of fluid 4) is equal to the difference of the liquid feed mixture 5 flow and sediments accumulating in heater 3.

The first line corresponding to the low temperature line connects heat exchanger 2 to heater 3 to transport the liquid feed mixture 5 for heating in heater 3. More particularly, liquid feed mixture 5 in heater 3 takes heat from an external heat source or chemical reactions which chemical reactions can occur in liquid mixture 5 and generating heat. The heat from the external heat and/or heat generated from chemical reaction are evaporating fluid 4 from liquid feed mixture 5. When balancing out the system, fluid 4 is a vaporizing liquid at a critical temperature and pressure, i.e., the critical point.

The separating fluid 4 has to have a minimal boiling temperature from all fluids in the feed mixture and . If water is a desired output from the liquid feed mixture 5, fluid 4 is water that is evaporated from liquid feed mixture 5, wherein fluid 4 in heater 3 is at 646.096 K and 22,060 kPa, which is the critical point of water. If ethanol is a desired output from the liquid feed mixture 5, fluid 4 is ethanol that is evaporated from liquid feed mixture 5, wherein fluid 4 in heater 3 is at 514 K and 6,300 kPa, which is the critical point of ethanol. Near critical point, there is no liquid/vapor, just a fluid which may be both or neither (supercritical fluid).

In the vicinity of the critical point, the physical properties of the liquid and the vapor change dramatically, with both phases becoming ever more similar. For instance, liquid water under normal conditions is an excellent solvent for electrolytes. Near the critical point, water becomes a bad solvent for electrolytes. Thus, near critical point, you do not need to evaporate the water. Just being in the vicinity of critical point will separate the solvent fluid from its solutes. The fluid that leaves heater 3, which is “an evaporator” is not necessarily vapor.

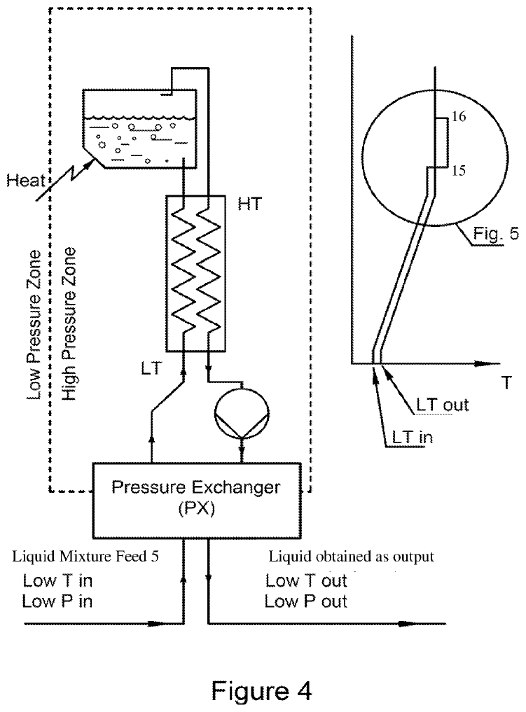

During the evaporation, the enthalpy of vaporization is zero. Fluid 4, when evaporated, is an outgoing vapor from heater 3 that is transported along a second line of heat exchanger 2 corresponding to the higher temperature and lower temperature regions. The second line corresponding to the higher and lower temperature regions operatively connects heat exchanger 2 with heater 3, pump 6, and pressure exchanger 1. Only heat exchanger 2 is cooling. It is important for recuperation of the thermal energy of liquid mixture feed 5. Any other potential ‘heat dissipators’ disbalance energy flow in the recuperation process. After exiting the heater 3, the outgoing fluid is cooled in heat exchanger 2 to a temperature close to a lower temperature (LT) of the liquid feed mixture 5, thereby decreasing the temperature to below critical point and yielding fluid 4 into a liquid state. Fluid 4 in the liquid state is an outgoing liquid received by pump 6 in the high-pressure zone, wherein pump 6 circulates fluids inside the high-pressure zone. Pump 6, which is operatively connected to pressure exchange 1 along the second line, feeds the outgoing liquid to pressure exchange 1. Pressure exchanger 1 takes pressure energy from outgoing liquid, wherein the outgoing liquid leaves the high-pressure zone into the low-pressure zone. High pressure zone may have pump 6 to circulate fluids inside high pressure zone or pump 6 may be absent due to gravitational flows inside the high-pressure zone . Fluid 4 leaves the pressure exchanger 1 at the low temperature and low pressure as a liquid. While pump 6 is depicted as residing in the high-pressure zone in a position proximal, pump 6 can reside in other positions in FIG. 4 without departing from the scope of the invention. Pump 6 can be installed in connection points which fluid flows from pressure exchanger 1 to heat exchanger 2 to heater 3 to heat exchanger 2 to pump 6 to pressure exchanger 1.

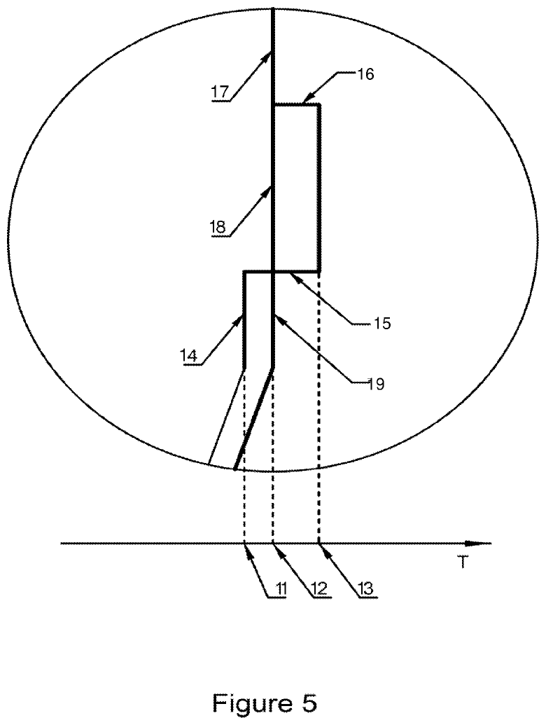

In heater 3, a clean fluid is heated to the be in the vicinity of the critical temperature of the liquid mix. For example, freshwater is produced from a liquid mix containing brine when transported to the heaters herein and undergoes heating. The critical point of brine is higher than the freshwater, wherein the freshwater has a critical temperature of 373.946° C. The liquid mix has a critical temperature higher than the critical temperature of the first clean fluid, wherein the temperature difference depends on solutes in the mix (i.e., the inset in FIG. 4 which is described further in FIG. 5). For seawater brine, there is about 10° C. gap depending on brine concentration, i.e. critical temperature is about 384° C. To get this temperature gap, the mix is heating in the heater 3.

It should be noted that for optimization of the system of the present invention, reaching critical temperature of the liquid mix in the heater 3 is preferable, as the usage of temperatures below the critical temperature decreases energy efficiency of the system , while the usage of temperatures higher than the critical temperature decreases the purification effect. Below the critical temperature, the latent heat grows and thus outgoing fluid 4 has a higher energy density than liquid feed mixture 5 and there is no room to place that energy difference, which decreases the energy efficiency of the system. The rising temperature of supercritical liquid increases adsorption abilities, thus the solubles from the mixture are absorbed, which decreases the purification effect.

However, the scope of the present invention extends beyond heating the liquid mix in the heater 3 to the exact critical temperature of the liquid mix. According to some embodiments of the present invention, the temperature of the liquid mix in the heater 3 is in the vicinity of the critical temperature of the liquid mix. The temperature difference or gap for effective separation of fluid 4 from the liquid mix is based on the concentration of the mixture and boiling properties of fluid 4. For saturated mixes, the temperature difference can be 10 degrees in Kelvin or higher.

FIG. 4 and FIG. 5 depict a temperature graph for energy efficient distillation process from FIG. 3, for balanced flows and temperatures.

The following reference numerals and letters are used in FIGS. 4 and 5:
11—Temperature of feed mixture entering heater (e.g., heater 3)
12—Critical temperature of vaporizing fluid which is leaving from the top of heater 3
13—Temperature of liquid mixture in heater
14—Section between heat exchanger and heater
15—Temperature gap between entrance temperature and temperature in the heater
16—Temperature gap between temperature of the mixture in the heater and critical temperature of fluid over the mixture
17—Temperature of fluid over the mixture
18—Temperature of fluid in the pipe between head of the heater and heat exchanger
19—Temperature of fluid upstream heat exchanger
LT in—Temperature of feed mixture entering heat exchanger
LT out—Temperature of outgoing fluid

Temperature 16 is the section between the exit of the heater 3 and the entrance to the heat exchanger. There is a temperature drop by virtue of the surface between the liquid mix and fluid 4 separates fluid 4 from the liquid mix and this process consumes energy.

The graph shows a cycle beginning downstream of Heat Exchanger. The feed mixture arrives at low temperature (LT in) and leaves through heat exchanger, where temperature rises to temperature 11, and the fluid enters heater. The mixture heats up in the heater to temperature 13, above the critical temperature of a vaporizing fluid 12. Then the fluid evaporates from the mixture at critical temperature 12 and goes up and enters the pipe to heat exchanger, see sections 17, 18, 19. Once in the heat exchanger, the fluid temperature drops from temperature 19 to LT out. The fluid liquidizes at the end of section 19, when the temperature of the fluid drops below critical temperature 12. In sections 18 and 19, the temperature is constant. The difference between temperatures LT in and LT out indicates the efficiency of proposed design. Temperature 15 (i.e., temperature gap between entrance temperature and temperature in the heater) corresponds an upper threshold and temperature 16 (i.e., temperature gap between temperature of the mixture in the heater and critical temperature of fluid under the mixture) corresponds to lower threshold. Therefore, pressure, temperatures and flows in the system need to be balanced out to minimize such difference and thus maximize energy efficiency of the whole system.

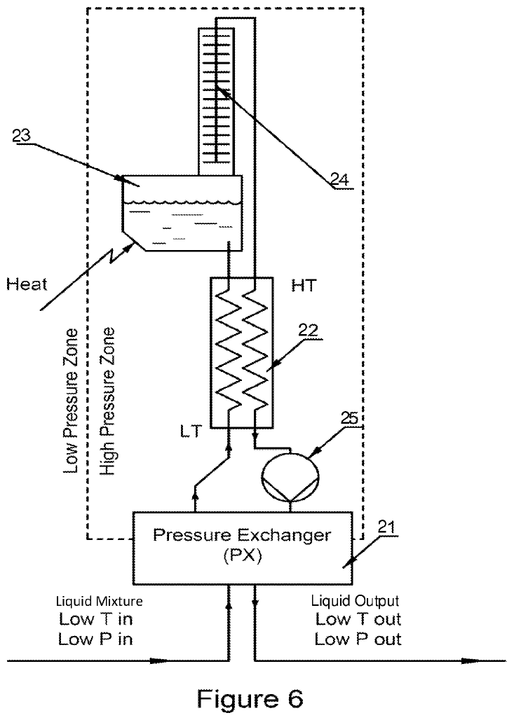

Referring to FIG. 6, the application of the energy efficient distillation process in fractional distillation is depicted.

The following reference numerals and letters are used in FIG. 6:
21—Pressure exchanger
22—Heat exchanger
23—Heater
24—Fractional column
25—Pump for high-pressure zone circulation

The schematic in FIG. 6 is very similar to basic energy efficient distillation in FIG.3. The only difference is fractional column 24 added in the path of a vaporized fluid and downstream heater 23. The fractional column here has the same purpose as in fractional distillation process, which cools, condenses, and vaporizes vaporized fluid multiple times until the fluid is purified at the head of the column. This setup can be used in the same applications as fractional distillation.

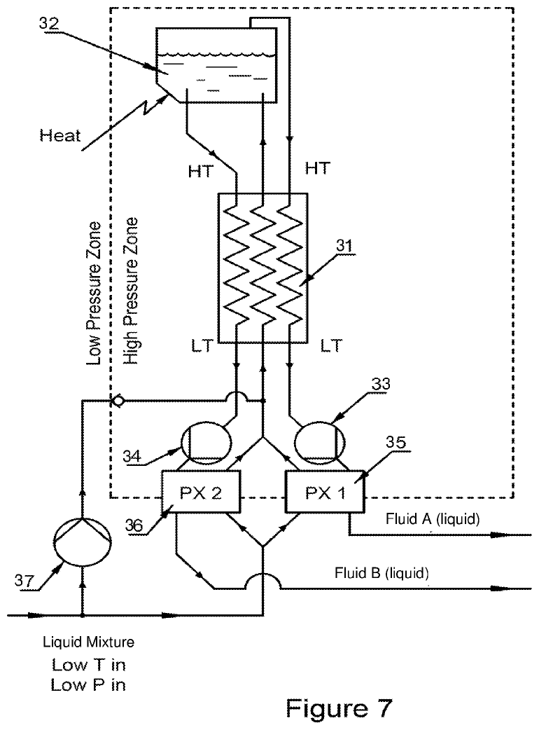

In FIG. 7, a continuous energy efficient distillation with full separation into two liquids is depicted. Continuous distillation, which is essentially a separation of feed mixture into two liquids with a full recovery of heat and pressure energies to distillation process, is depicted.

The following reference numerals and letters are used in FIG. 7:
31—Three fluid heat exchanger
32—Heater
33—Fluid A high pressure zone circulation pump
34—Fluid B high pressure zone circulation Pump
35—Fluid A Pressure Exchanger
36—Fluid B Pressure Exchanger
37—High Pressure Pump

The major variation from the basic energy efficient distillation schematic is a line of non-vaporized liquid leaving the heater 32. The liquid, which passes through: the three fluid Heat Exchanger 31 and circulating pump 34, leaves through pressure exchanger 36. The three fluid Heat Exchanger 31 has the same temperature, as in the basic process schematic, with low temperature on one side and high temperature on the other. Heat exchanger 31 has 3 pair of connections (i.e., lines) and the temperature in the heat exchanger can be very different (which depends on flow directions, streams, and not from materials). For maximum heat recuperation, the heat exchanger 31 achieves low temperatures on the bottom side and high temperatures to the other side with minimum differences between low temperatures of the streams and minimum differences between high temperatures of the streams. The sum of the downstream setup is equal to the upstream setup, thereby the pressure exchanger output cross creates the sum of upstream setup.

Fluids A and B are not separate fluids in the liquid feed mixture (i.e., fluids A and B are not in purified form in the liquid feed mixture).

In heater 32, the liquid feed mixture (containing fluid A, fluid B, and solutes such as salts and other dissolved solids) is brought to the vicinity of critical state of fluid A and separates from its solutes (as the liquid loses its capability as a solvent). Fluid B containing solutes drains out along the left connection line operatively connected to bottom of heater 32. The purified liquid corresponding to fluid A is taken from the top of heater 32, wherein the top of heater 32 is operatively connected to a right connection line.

For example, if the liquid mixture is crude salt water, liquid A would be distilled water (or water with low salt levels), while liquid B is brine (salt water with high salt levels).

The main process flows are going through pressure exchanger 35 (which transports and obtains fluid A along the right-side connection of heat exchanger 31) and pressure exchanger 36 (which transports and obtains fluid B along the left-side connection of heat exchanger 31), while high pressure pump 37 is used only to fill the system at the startup and compensate for inefficiencies of pressure exchangers. The high-pressure pump 37 is pumping the low-pressure liquid mixture to the high-pressure zone. Through the center connection of heat exchanger 31, the liquid mixture arrives in the heat exchanger 31 at a low temperature and subsequently transported to heater 32 for heating. Vapor corresponding to fluid A, which leaves at higher temperatures from heater 32, is transported along the right-side connection of heat exchanger 31 for condensation as an outgoing liquid corresponding to fluid A. Fluid B, which may leave at higher temperatures from heater 32, is transported along the left-side connection of heat exchanger 31 as an outgoing liquid corresponding to fluid B. In other instances, there may be some heat exchanging processes in heater 32 which decrease the temperature differences for permitting the transport of fluid B along the left-side connection of heat exchanger 31 as an outgoing liquid corresponding to fluid B.

Additionally, the right and left side connections of the heat exchanger 31 are operatively connected to high-pressure zone circulation pump 33 and high-pressure zone circulation pump 34, respectively. High-pressure zone circulation pump 33 and high-pressure zone circulation pump 34 are: (i) receiving the outgoing liquid corresponding to fluid A and outgoing liquid corresponding to fluid B, respectively, from heat exchanger 31; and (ii) transporting the outgoing liquid corresponding to fluid A and outgoing liquid corresponding to fluid B to pressure exchanger 35 and pressure exchanger 36, respectively. The outgoing liquids corresponding to fluids A and B are obtained in pure form at a lower temperature and a lower pressure after exiting pressure exchanger 35 and pressure exchanger 36, respectively.

To compensate for the inefficiency of pressure exchangers 35 and 36 due to compressibility of liquids (e.g., fresh water losing about 1% of its volume at 221 bars), a feeding line with a pump can be used (see FIG. 7). But in some cases, the feeding line can be obviated as depicted in FIG. 3.

What is claimed is:

1. A distillation system, comprising:
a heater;
a first feed line configured to deliver a liquid feed mixture at a first pressure and a first temperature;
a pressure exchanger configured to change a fluid pressure of the liquid feed mixture to a level above the first pressure to a vicinity of a critical pressure of a vaporizing fluid;
a countercurrent heat exchanger configured to receive the liquid feed mixture from the pressure exchanger and to heat the liquid feed mixture;
wherein the heater is configured to receive the liquid feed mixture and to heat the liquid feed mixture to a temperature in a vicinity of the critical pressure of a vaporizing fluid, thereby yielding the vaporizing fluid as an outgoing fluid near a critical point thereof;
wherein the outgoing fluid from the heater is received by the countercurrent heat exchanger such that the liquid feed mixture is heated to a temperature proximate to the outgoing fluid and the outgoing fluid is cooled in the countercurrent heat exchanger, thereby condensing the outgoing fluid into an outgoing liquid; and
wherein the pressure exchanger is configured to receive the outgoing liquid from the heat exchanger such that the pressure exchanger reduces a pressure of the outgoing liquid in order to increase the fluid pressure of the liquid feed mixture to a level above the first pressure to at least a critical pressure of the vaporizing fluid, and output the outgoing liquid.

2. The distillation system of claim 1, further comprising a pump for circulating the liquid feed mixture, outgoing fluid, and outgoing liquid.

3. The distillation system of claim 1, further comprising a fractional column configured to receive the outgoing fluid from the heater for cooling, condensing, and vaporizing the outgoing fluid multiple times until the outgoing fluid is purified at an end of the fractional column; wherein the end of the fractional column is connected to the countercurrent heat exchanger.

4. A distillation system, comprising:
a heater;
a first feed line configured to deliver a liquid feed mixture at a first pressure and a first temperature;
a first pressure exchanger configured to change a fluid pressure of the liquid feed mixture to a level above the first pressure to at least a critical pressure of vaporization of a vaporizing fluid;
a second pressure exchanger configured to change a fluid pressure of the liquid feed mixture to a level above the first pressure to at least a critical pressure of vaporization of the
a countercurrent heat exchanger configured to receive the liquid feed mixture from both first and second pressure exchangers and to transport the liquid feed mixture to the heater;
wherein the heater is configured to receive the liquid feed mixture, heat the liquid feed mixture, and vaporize the liquid feed mixture into an outgoing vapor;
wherein the countercurrent heat exchanger is configured to receive the outgoing vapor and receive a second outgoing liquid via two separate lines from the heater such that the liquid feed mixture is heated to a temperature proximate to the outgoing vapor and the outgoing vapor is cooled into a first outgoing liquid;
wherein the first outgoing liquid is cooled in the countercurrent heat exchanger and the first pressure exchanger is configured to receive the first outgoing liquid from the heat exchanger such that the pressure exchanger reduces a pressure of the first outgoing liquid in order to increase the fluid pressure of the liquid feed mixture to a level above the first pressure to at least a critical pressure of the vaporizing fluid, and output the first outgoing liquid; and
wherein the second outgoing liquid is cooled in the countercurrent heat exchanger and the second pressure exchanger is configured to receive the second outgoing liquid from the heat exchanger such that the pressure exchanger reduces a pressure of the second outgoing liquid in order to increase the fluid pressure of the liquid feed mixture to a level above the first pressure to at least a critical pressure of the vaporizing fluid, and output the second outgoing liquid.

5. The distillation system of claim 4, wherein the first feed line is divided into a second and third feedline that feeds the respective first and second pressure exchangers.

6. The distillation system of claim 4, further comprising respective output lines from the first and second pressure exchangers that combine into a single line feeding into the countercurrent heat exchanger.

7. The distillation system of claim 4, wherein the first line is operatively connected to a pump the liquid feed mixture to the concurrent heat exchanger.
